(19) United States
(12) Patent Application Publication
(10) Pub. No.: US 2011/0310088 A1
(43) Pub. Date: Dec. 22, 2011

(54) PERSONALIZED NAVIGATION THROUGH VIRTUAL 3D ENVIRONMENTS

(75) Inventors: Neeharika Adabala, Bangalore (IN); Komal Prjapathi, Lucknow (IN); Gurpreet Singh Bagga, Jalandhar Cantonment (IN)

(73) Assignee: Microsoft Corporation, Redmond, WA (US)

(21) Appl. No.: 12/817,497

(22) Filed: Jun. 17, 2010

(51) Int. Cl. G06T 15/00

(52) U.S. Cl. 345/419

(57) ABSTRACT

Personalized navigation technique embodiments are presented that generally involve providing personalized navigation through a virtual three-dimensional (3D) environment. In one general embodiment this is accomplished by inputting a representation of a virtual 3D environment that is to be navigated, along with a number of user specified navigation preferences, and outputting a customized navigation experience. This navigation experience is produced by first establishing a path through the virtual 3D environment, and then optionally controlling the behavior of a virtual camera which reveals the virtual 3D environment to the user as the user traverses the path. Both the path and the virtual camera behavior are personalized to a user based on the aforementioned navigation preferences.

### BACKGROUND

A significant amount of work has been done in the area of path planning for the navigation of virtual three-dimensional (3D) environments. Typically, this involves computing a path through the environment from a start location to a destination location while considering some fixed constraints that are incorporated into the solution.

One virtual environment that such approaches have been applied to is that of a photosynth. A photosynth uses a collection of photographs of a scene that have been aligned in three-dimensional (3D) space to create a 3D navigation experience. More particularly, a set of images that efficiently represents the visual content of a given scene are selected. The distribution of these images is examined and a set of canonical views is selected to form a scene summary. Typically, this is accomplished using clustering techniques on visual features depicted in the images. Stereo matching is often employed to intelligently choose images that match, and this matching information is then used to create 3D models of the environment. A by-product of the photosynth creation process is the establishment of a feature point cloud and keyframe points. The feature point cloud is the set of 3D matching points identified among the images making up the photosynth, and a keyframe point represents a location where a camera was situated when capturing a photosynth image.

### SUMMARY

This Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

Personalized navigation technique embodiments are described herein that generally involve providing personalized navigation through a virtual three-dimensional (3D) environment. In one general embodiment this is accomplished by inputting a representation of a virtual 3D environment that is to be navigated, along with a number of user specified navigation preferences, and outputting a customized navigation experience. This navigation experience is produced by first establishing a path through the virtual 3D environment, and then optionally controlling the behavior of a virtual camera which reveals the virtual 3D environment to the user as the user traverses the path. Both the path and the virtual camera behavior are personalized to a user, based on the aforementioned navigation preferences.

The navigation path is progressively defined from a course to more detailed levels, and at each stage there are user controllable parameters that enable creation of alternative paths. Once a path is defined an additional level of richness can be added to the viewing experience by controlling virtual camera behavior while navigating along the path. The experience can be further personalized by using virtual camera motion and cinematographic effects to reflect personal interests of the user.

### DESCRIPTION OF THE DRAWINGS

The specific features, aspects, and advantages of the disclosure will become better understood with regard to the following description, appended claims, and accompanying drawings where:

FIG. 1 is a flow diagram generally outlining one embodiment of a process for providing personalized navigation through a virtual three-dimensional (3D) environment.

FIGS. 2A-B are a continuing a flow diagram generally outlining an implementation of a part of a preprocessing stage of the process of FIG. 1 involving defining a more concise region within the virtual 3D environment through which the path being generated will be routed and the creation of a region of interest grid.

FIG. 3 is a diagram depicting in simplified form an exemplary region of interest grid.

FIG. 4 is a flow diagram generally outlining an implementation of a part of the preprocessing stage of the process of FIG. 1 involving the construction of a region of interest graph.

FIG. 5 is a flow diagram generally outlining an implementation of a part of the preprocessing stage of the process of FIG. 1 involving the construction of a static force grid.

FIG. 6 is a flow diagram generally outlining an implementation of a part of the process of FIG. 1 involving the construction of a course road-map graph.

FIG. 7 is a flow diagram generally outlining an implementation of a part of the process of FIG. 1 involving refining the course road-map path through the virtual 3D environment in a first refinement stage.

FIG. 8 is a flow diagram generally outlining an implementation of a part of the process of FIG. 1 involving refining a segment of the first refined path through the virtual 3D environment in the second refinement stage.

FIG. 9 is a flow diagram generally outlining an implementation of an optional part of the process of FIG. 1 involving establishing user navigation preferences.

FIG. 10 is collection of exemplary tables of elemental camera behaviors that are grouped to reflect a particular personality type and type of place.

FIG. 11 is a diagram depicting a general purpose computing device constituting an exemplary system for implementing personalized navigation technique embodiments described herein.

### DETAILED DESCRIPTION

In the following description of personalized navigation technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 Personalized Navigation Through Virtual 3D Environments

The personalized navigation technique embodiments described herein generally involve providing personalized navigation through a virtual three-dimensional (3D) environment.

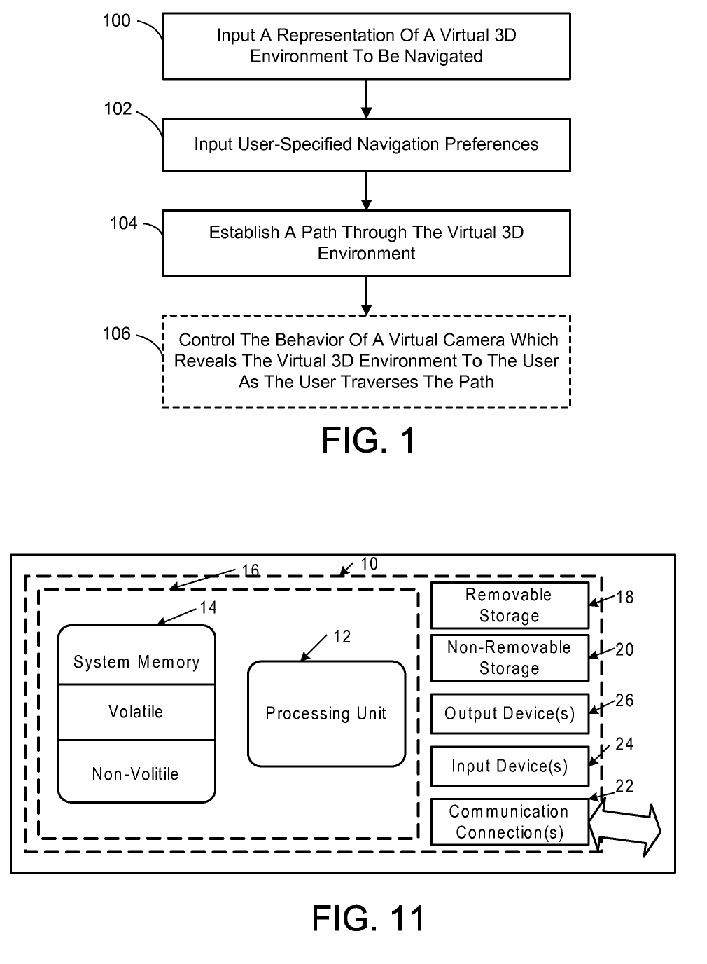

Referring to FIG. 1, in one general embodiment this is accomplished by inputting a representation of a virtual 3D environment that is to be navigated (100), along with a number of user specified navigation preferences (102), and outputting a customized navigation experience. This navigation experience is produced by first establishing a path through the virtual 3D environment (104), and then optionally controlling the behavior of a virtual camera which reveals the virtual 3D environment to the user as the user traverses the path (106). Both the path and the virtual camera behavior are personalized to a user, based on the aforementioned navigation preferences. It is noted that the optional nature of the camera control action is indicated by a broken line box in FIG. 1.

A path generation portion of the personalized navigation technique embodiments described herein generally involves creating customizable navigation paths through a virtual 3D environment based on the user inputs. The particular virtual 3D environment envisioned is embodied by a photosynth. However, even though the descriptions to follow will reference the photosynth embodiment, it is noted that other virtual 3D environment embodiments could also be employed as long as they are capable of providing the aforementioned feature point cloud and keyframe information that a photosynth is capable of providing.

In general, establishing a path through the virtual environment involves projecting a representation of the virtual environment onto a walk-through plane and defining paths on this plane based on various criteria. The path is first defined at a coarse level of detail and then progressively refined by taking more features from the virtual scene into account. In addition, path generation at each level of detail supports user input parameters that enable creation of alternative navigation paths. The technique embodiments specifically leverage the aforementioned keyframes and feature point cloud, which are generated as by-products of the photosynth creation process.

In regard to the aforementioned virtual camera control instructions, consider the situation where a group of people visit a particular real world site (e.g., park, monument, museum) and each of them pays attention to different aspects of the place, even though they may follow the same path. That is, their experiences are different despite following the same path. For example, a child's view of the world on the path may be totally different from an adult's experience. Inspiration can be taken from this example of human behavior to provide a richer and more personalized viewing experience. More particularly, once a path is defined an additional level of richness can be added to the viewing experience by controlling virtual camera behavior while navigating along the path. In addition, the experience can be personalized by using virtual camera motion and cinematographic effects to reflect personal interests. In other words, by combining virtual camera motion and effects, a style or personality can be associated with the virtual camera. In this way, different viewing experiences can be created for each user to mimic the real world experience of a different people following the same path through an environment at the same time, yet having a different experience based on their interests and personality.

The following sections provide a more detailed description of the path generation and virtual camera control aspects of the personalized navigation technique embodiments.

### 1.1 Path Generation

The path generation aspects of the personalized navigation technique embodiments described herein involve a pre-processing stage and three path generation stages which progressively define and refine navigation paths through the virtual environment. The three path generation stages are a road-map generation stage, a first refinement stage (which in one embodiment employs an “A*” or A-star” refinement technique) and a second refinement stage (which in one embodiment employs a potential field-driven interpolation technique).

The road-map generation stage provides a course path through the virtual environment. The route of this course path reflects user objectives based on user-specified parameters. Thus, different user-specified parameters will result in the path taking a different route through the virtual environment. The first refinement stage serves to refine the course path produced by the roadmap stage to a resolution consistent with the photosynth data. The second refinement stage is used to refine the path established in the first refinement stage so as to give the user a more realistic experience. For example, in the embodiments employing the aforementioned potential field-driven interpolation, the path can be modified to include smooth curves.

It is noted that all three levels of the path generation hierarchy work independently from each other. Thus, introducing variation in one stage will not influence the parameter settings employed by successive stages.

### 1.1.1 Preprocessing

The feature point cloud and keyframe data obtained from the photosynth is not directly usable to define navigation paths. Therefore, this data is first preprocessed before being used in the path generation stages. In general, the preprocessing involves first defining a more concise region in the virtual environment where the path will be laid out, building a graph of this region, and setting up a static force grid of the region. It is noted that the preprocessing generates static data structures and need only be done once for a photosynth representation of a virtual environment. Thus, once the preprocessing for a photosynth is complete, the resulting graphs and grids can be used and reused to generate any number of paths through the environment. The following sections provide a more detailed description of the preprocessing.

### 1.1.1.1 Defining a More Concise Region

As indicated previously, a by-product of creating a photosynth is the establishment of a feature point cloud and keyframe points. The feature point cloud is the set of 3D matching points identified among the images making up the photosynth, and a keyframe point represents a location where a camera was situated when capturing a photosynth image. In this preprocessing stage, the feature point cloud is used to define the extent of a region of the virtual environment in which navigation paths are allowed to traverse. Since the point cloud is generated by matching features in photographs, some of the points that are generated can be spurious and may occur in the sky or outlier regions of the photographs that do not have significant parts of interest. The aforementioned path generation stages employ a grid representation of the virtual environment. Including spurious and outlier points can lead to a large grid in which many cells are empty or sparsely populated with feature points. This in turn leads to inefficient computation where significant time in spent on empty cells. Therefore, it is advantageous to limit the grid to a region that is densely populated with feature points to improve the quality of the paths that are generated.

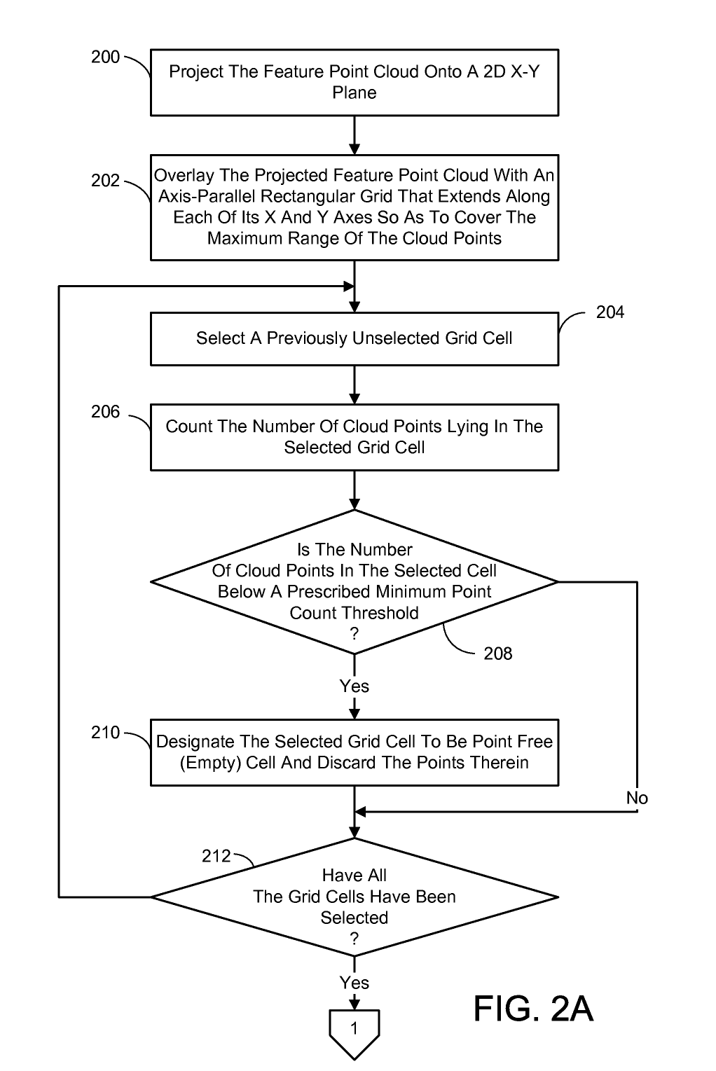

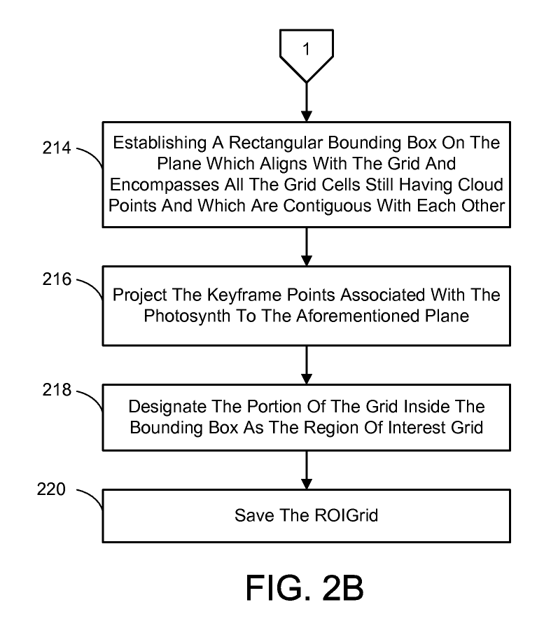

Referring to FIGS. 2A-B, in one embodiment this is accomplished as follows. The region of interest is reduced by first projecting the point cloud onto a 2D X-Y plane (200). In one implementation, this plane transects the 3D virtual environment as represented by the feature point cloud of a photosynth such that it is substantially parallel with a prescribed ground level of the environment and at a height above the ground level approximately corresponding to an adult's eye-level. The projected point cloud is then overlain with an axis-parallel rectangular grid that extends along each of its X and Y axes so as to cover the maximum range of the cloud points (202). The orientation of the perpendicular X-Y axes on the plane can be chosen arbitrarily. In addition, the grid has rectangular shaped grid cells are sized so that they are smaller than the average distance between landmark regions, which are clusterings of keyframe locations as will be described more fully in the description of the road-map generation stage. A previously unselected grid cell is selected next (204), and the number of cloud points lying in the selected grid cell is counted (206). It is then determined if the number of cloud points in the selected cell is below a prescribed minimum point count threshold (208). In one implementation, the minimum point count threshold was set to 100*(width/wn)*(height/hn), where width and height are the width and height of the grid, and wn=number of grid cells along the width, and hn=number of grid cells along the height. If the number of points found in the selected grid cell is found to be below the minimum point count threshold, the grid cell is designated as a point free (empty) cell and the points therein are discarded (210). Otherwise, no action is taken. Next, it is determined if all the grid cells have been considered (212). If not, then process actions 204 through 212 are repeated. When all the grid cells have been considered, a rectangular bounding box is established on the plane which aligns with the grid, and encompasses all the grid cells still having cloud points which are contiguous with each other (214). It is noted that this can result in outlying cells with points being excluded from the bounding box. It is also noted that because the bounding box is rectangular, it can (and is likely to) contain some empty cells. Once the bounding box has been established, the keyframe points associated with the photosynth are projected to the aforementioned plane (216). The portion of the grid inside the bounding box is then designated as the Region of Interest Grid or ROIGrid for short (218). The path being established through the virtual environment will be restricted to the region defined by the ROIGrid. The ROIGrid is then saved for future processing (220). This includes storing the projected locations of the feature cloud and keyframe points that fall inside the bounding box, as well as their associated grid cell.

FIG. 3 illustrates the foregoing where the grid 300 covers projected feature cloud points 302, and all the cells 304 having less than the minimum point count threshold number of points having been made into empty cells. In addition, the aforementioned bounding box 306 has been established to encompass the contiguous cells 308 still having points therein. Note that this leaves some outlying cells having point (such as cells 310) outside the box 306. As indicated previously, the portion of the grid inside the bounding box 306 is the ROIGrid 312.

### 1.1.1.2 Building a Graph of the Region of Interest

In those embodiments where the A-star technique is used in the first refinement stage, a graph of the region of interest defined by the ROIGrid is used as an input. This graph will be referred to hereinafter as the Region Of Interest Graph or ROIGraph for short.

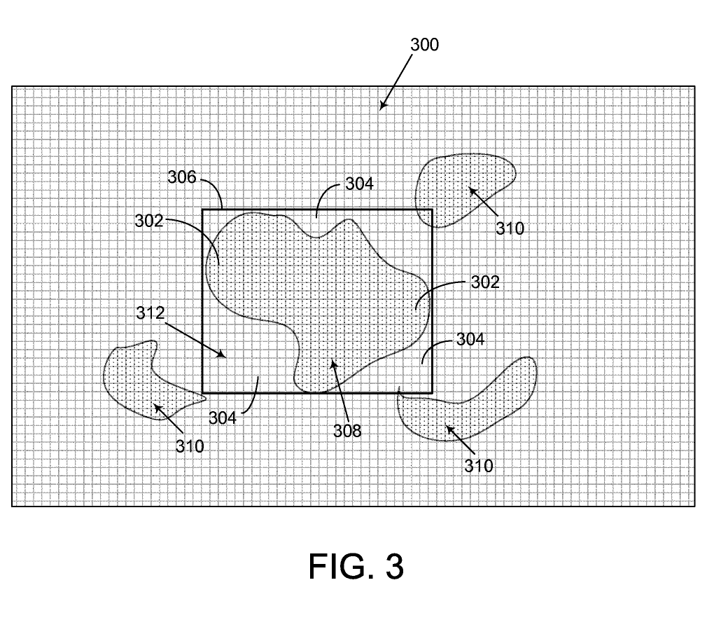

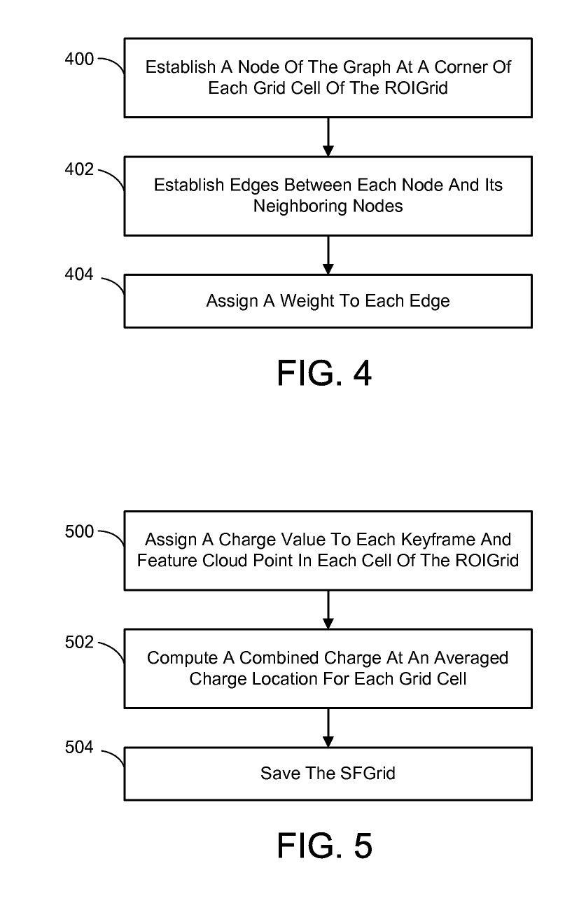

Referring to FIG. 4, in one embodiment the ROIGraph is constructed as follows. First, a node of the graph is established at the bottom left corner of each grid cell of the ROIGrid (400). It is noted that the choice of the bottom left corner of each cell is arbitrary. Any of the other cell corners or any prescribed location within a grid cell could be chosen instead, as long as the same location is chosen in each of the grid cells. Edges are then established between each node and its neighboring nodes (402). For the purposes of constructing the ROIGraph, all the nodes corresponding to cells adjacent to that associated with a given node, are deemed to be the only neighbors to that node. A weight is then assigned to each edge (404). In general, the edge weights can be computed based on a variety of parameters depending upon qualities of the path. For example, these parameters can include, but are not limited to, the number of feature cloud points and keyframes in the cell associated with the node where the edge originates, the Euclidean edge length, and the number of feature cloud points and keyframes in the cell associated with the node where the edge terminates. In one implementation, the edge weights are computed as follows:

$$edge weight = ( {\sum }_{i ∈ ncells} \frac{{nPoints}_{i}}{maxPoints * {nkeyframes}_{i}} ) \qquad ( 1 )$$

where ncells represents the grid cells that have the edge as a side, nPointsᵢ is the number of points in the i^{th} cell, and nkeyframesᵢ represents the number of keyframes in the i^{th} cell.

### 1.1.1.3 Building a Static Force Grid

This preprocessing task is performed using the ROIGrid as input and results in the establishment of a Static Force Grid or SFGrid for short. The SFGrid is used in the aforementioned second refinement stage to further refine the path within the grid cells by considering obstacles. A SFGrid is a data-structure that stores, for each grid cell, a charge value associated with an averaged charge location within the cell.

Referring to FIG. 5, in one embodiment the SFGrid is constructed as follows. First, for each cell of the ROIGrid, a charge value is assigned to each keyframe and feature cloud point in the cell (500). The value of the charge assigned to each point is generally based on the nature of path required. Typically, the keyframe points are assigned an attracting charge, while the feature cloud points are assigned a repulsive charge. This is done as a keyframe corresponds to a location where a camera has a good view in some direction, and the feature cloud points represent locations where features (therefore implied objects/obstacles) are present in 3D space.

In one embodiment, the charge value assigned to a keyframe point is established in the range of [−10,−100], where a more negative value attracts the path closer to keyframe. Further, the charge value assigned to each feature cloud point is establish in the range of [0,1]. In tested embodiment, the feature cloud point charge value was set to 1.

Once a charge has been assigned to each keyframe and feature cloud point in the ROIGrid, a combined charge at an averaged charge location is computed for each grid cell (502). In general, the averaged charge location of a cell is computed as the mean location of all the keyframe and feature cloud point within the cell and the combined charge assigned to this location is computed as the sum of the charges assigned to each keyframe and feature cloud point within the cell weighted by the distance of the point from the averaged charge location of the cell. In one implementation, the (x, y) location of combined charge for a cell of the SFGrid is computed as follows:

$${cellChargeLoc}_{x} = \frac{\begin{matrix}( {\sum }_{points ∈ GridCell} {pointLoc}_{x} * pointCharge ) + \\ ( {\sum }_{KF ∈ GridCell} {KFLoc}_{x} * KFCharge )\end{matrix}}{TotalCharge} \\ {cellChargeLoc}_{y} = \frac{\begin{matrix}( {\sum }_{points ∈ GridCell} {pointLoc}_{y} * pointCharge ) + \\ ( {\sum }_{KF ∈ GridCell} {KFLoc}_{y} * KFCharge )\end{matrix}}{TotalCharge} \qquad ( 2 )$$

where TotalCharge=Σ_{points,KF∈Grid/Cell} Charge and is it is the sum of all charges associated with points and keyframes that occur in the particular grid cell under consideration. KF is the keyframes in the cell and point is the feature point clouds points. The SFGrid is then saved for future processing (504). This includes storing the averaged charge location and combined charge for each cell.

### 1.1.2 Road-Map Generation

As indicated previously, the road-map generation stage establishes a course path through the virtual environment. The route of this course path reflects user objectives based on user-specified parameters. In this way, different user-specified parameters will result in the path taking a different route through the virtual environment.

The road-map represents an over-head abstraction of the region of interest of a photosynth as defined in the ROIGrid established in the preprocessing stage. In one embodiment, the road-map takes the form of a graph. To generate this road-map graph, it is first assumed that each keyframe location within the region of interest represents a landmark location. It is presumed that these landmark locations provide an exhaustive estimate of landmarks in the region of interest, because keyframes represent the camera locations of actual photographs taken. It is further assumed that these keyframes are large in number, and concentrated around locations due to presence of multiple photographs of same landmarks in a photosynth.

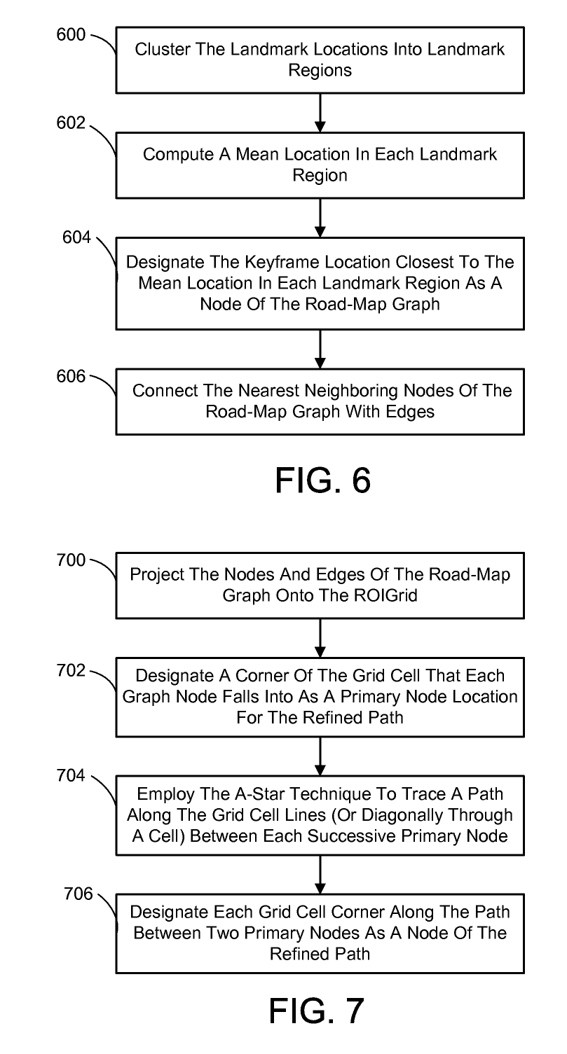

Given these assumptions, in one embodiment the road-map graph is generated as shown in FIG. 6. First, the landmark locations are clustered into landmark regions (600). While any suitable clustering method can be employed for this task, in one implementation, an agglomerative hierarchical clustering technique is employed. In general, this technique uses the mean Euclidean distance between landmark locations as a metric to achieve the clustering. More particularly, initially every landmark location is treated as a candidate landmark region. The clustering is then achieved by recursively merging pairs of neighboring candidate landmark regions that are closest to each other, and closer than a user-selected distance threshold. When the minimum distance between every pair of landmark regions is greater than the distance threshold, the remaining candidate landmark regions are designated as the final landmark regions. It is noted that all the distance measurement in foregoing technique are based on the 2D projected locations of the keyframe points in the region of interest.

Once the clustering has produced a number of final landmark regions, a mean location is computed in each region (602), and the keyframe location closest to this mean location is designated as a node of the road-map graph (604). The nearest neighboring nodes of the road-map graph are then connected with edges (606). It is noted that if there is a tie in closeness between a group of nodes, the nearest neighboring node is chosen arbitrarily.

It is further noted that in the above-described agglomerative hierarchical clustering technique, the user specifies the minimum distance that can exist between landmark regions. Varying the minimum distance threshold can affect the number of landmark regions established, and so the number of nodes in the road-map graph. Thus, depending on the user-specified distance threshold, different course paths will be generated through the virtual environment.

Establishing a course path road-map from the road-map graph involves inputting user specified parameters. Depending on these user-specified parameters, a specific type of graph traversal procedure will be chosen to produce a customized course path road-map through the virtual environment.

A user may visit a virtual environment for different reasons. For example, the user may wish to make a virtual visit to the environment. In such a visit, the virtual experience itself is the end goal. As such, it is assumed the user wants to see all the details of the virtual environment. This is akin to a traveling salesman problem where the task is to find a shortest possible route that visits each of a set of locations (e.g., the landmark regions) just once. If the user chooses this exhaustive walk type of visit, all of the nodes (representing the landmark regions) in the road-map graph are used to generate the course path road-map and the aforementioned edges will represent the inter-landmark region pathways of a road-map.

Another reason a user might want to visit a virtual environment representing a real world place (as photosynths typically do), is to make plans for an impending physical trip to the site. In such a case, the user may want to find optimal paths to take with certain limitations. For instance, the user might want to visit a selected number of the points of interest (which are assumed to correspond to the aforementioned landmark regions) at a site in shortest amount of time. It is assumed that the identity of the landmark regions is available from the photosynth. To provide a course path road-map of this selective walk-through type of visit, all but the nodes representing the landmark regions corresponding to the points of interest selected by the user are ignored in the full road-map graph. The remaining nodes under consideration are then connected with edges in the manner described previously. The result is then a course path road-map providing the optimal path through the virtual environment that visits all the user-selected points of interest. The optimal path represents the shortest travel distance and so is assumed to comply with the shortest time restriction.

In a variation of the last scenario, assume the user has no prior knowledge of the points of interest in the virtual environment. In such a case, the user is presented with a list of points of interests corresponding to the landmark regions used to establish the nodes of the full road-map graph and the user selects the points of interest he or she desires to visit. The rest of the procedure for establishing the course path road-map is then the same.

In yet another variation, instead of the user selecting from a list of points of interest, prescribed packages of the points of interest could be employed based on user-specified personality traits. For example, assume the user inputs their age and based on this it is determined the user is a child. A set of landmark regions that are believed to be of interest to a child could be pre-determined and employed to generate a customized course path road-map in the manner described previously. Other sets of landmark regions can similarly be pre-determined for teenagers, adults and seniors. Further, sets of landmark regions could be pre-determined based on user-specified traits other than age.

### 1.1.3 First Refinement Stage

As indicated previously, the first refinement stage serves to refine the course path produced in the roadmap stage to a resolution consistent with the photosynth data. It is noted that in cases where the resolution of the course path road-map is sufficient for the application, the first and second refinement stages can be skipped.

In one embodiment of the first refinement stage, the coarse path is refined by defining a detailed path on the ROIGrid using the A-star technique. In general, the purpose of the A-star refinement technique is to refine the path obtained by traversing the road-map to a level of detail that is defined by the ROIGrid resolution. In other words, the first refinement stage defines the details of the path taken through the virtual environment between the nodes of the road-map graph. Apart from providing a more detailed definition of path, this stage also allows for variation in details of the path. This variation is achieved by varying the parameters used in the cost function of the A-star technique based on user-specified parameters.

The inputs to the A-star technique are the road-map graph, the ROIGrid and the ROIGraph. In general, the A-star technique is separately applied to successive road-map graph nodes to refine the path between them to the resolution of the ROIGrid. Each of the resulting refined path segments is represented by a node sequence (i.e., ROIGrid indices sequence).

In one embodiment, the refined path is computed as shown in FIG. 7. First, the nodes and edges of the road-map graph are projected onto the ROIGrid (700). The lower left hand corner of the grid cell that each graph node falls into is then designated as a primary node location for the refined path in the ROIGrid (702). It is noted that the choice of the bottom left corner of each cell is arbitrary. Any of the other cell corners or any prescribed location within a grid cell could be chosen instead, as long as the same location is chosen in each of the grid cells and the choice corresponds to the location selected for use in creating the ROIGraph. The A-star technique is then used to trace a path along the grid cell lines between each successive primary node using the order of the nodes from the road-map graph as a guide to the primary node sequence (704). The A-star technique uses the edge weights computed for the edges in the ROIGraph which correspond to the grid cell lines to compute the refined path. Each grid cell corner along the path between two primary nodes is then designated as a node of the refined path (706). It is noted that in one implementation, the A-star technique can specify that the path follows a diagonal line from one corner to another of a cell, rather than just following the cell lines.

The A-star technique is a best-first graph search method that finds the least-cost path in a graph. It uses a distance-plus-cost heuristic function to determine the order in which the search visits nodes in the graph. As indicated previously, it is the parameters of this cost function that can be varied based on user inputs to vary the resulting refined path. As with the road-map, these parameters can be specified directly by the user, or the user can choose from a prescribed list of personality trait related items each of which is associated with prescribed parameter values that affect the A-star technique's cost function in a way that reflects the selected personality trait. For example, if a person selects certain regions as more interesting to them, then edges in this region are given more weight by suitably modifying the terms of the cost function. Therefore, paths through this region would be selected while traversing the roadmap.

### 1.1.4 Second Refinement Stage

The second refinement stage produces a more realistic, smooth trajectory between two adjacent nodes (which correspond to the grid cells) of the refined path generated by the first refinement stage. Of course, if such a further refinement is not deemed necessary for the application, then the second refinement stage can be skipped.

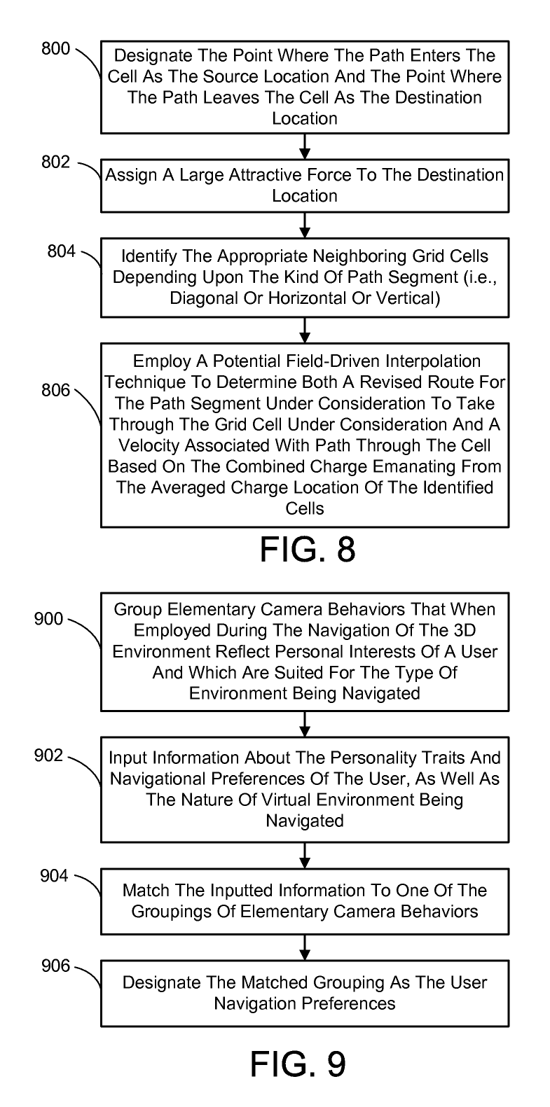

In one embodiment of the second refinement stage, the path defined in the first refinement stage is further refined using the aforementioned well-known potential field-driven interpolation technique. This technique uses the refined path output from the first refinement stage and the SFGrid as inputs. In one implementation, the refined path is computed as shown in FIG. 8. First, for each segment of the first refinement stage path traversing a grid cell (which forms one of the edges or a diagonal of the grid cell as indicated previously), the point where the path enters the cell is designated as the source location and the point where the path leaves the cell is designated as the destination location (800). The destination location is then assigned a large attractive force (802). For example, this attractive force can be set in the range [−1000,−10000]. Next, depending upon the kind of path segment (i.e., diagonal or horizontal or vertical), the appropriate neighboring grid cells are identified (804). For example, if the path segment is horizontal along an edge of the grid cell, the cells immediately above and below it on the grid are identified. If the path segment is vertical along an edge of the grid cell, the cells immediately before and after it on the grid are identified. If the path segment is diagonal through the grid cell, the cells immediately above, below, before and after it on the grid are identified. Next, the combined charge emanating from the averaged charge location of the selected cells as indicated by the SFGrid are used by the potential field-driven interpolation technique to determine both a revised route for the path segment under consideration to take through the grid cell under consideration and a velocity associated with path through the cell (806). The velocity refers to how fast a user following the path moves through the cell.

Using the potential approach makes it possible to create paths from a human's perspective of obstacle avoidance because the repulsing charges of the feature cloud points that went into the computation of the combined charge for the grid cell locations represent where features (and therefore implied objects/obstacles) are present in 3D space. This leads to generation of realistic, smooth and continuous interpolation paths. The path need not comply with any fixed template or grid. It is modified if an obstacle appears in its neighborhood.

It is noted that the foregoing cell-by-cell approach also aids in the prevention of oscillations and local minima in the computation of the path. More particularly, the local minima are avoided by employing the aforementioned attractive charge at the destination point of each cell. In addition, considering only points in the immediate vicinity to generate the charge forces, cuts down force interactions between points, thereby making the progress along the path less prone to oscillations.

It is further noted that the charge value assigned to each keyframe and feature cloud point in the generation of the SFGrid, as well as the value of the attractive charge applied to the destination point in each cell, can be user-specified. This gives the user a say in the degree that the path is modified and in the velocity assigned to each cell by the potential field-driven interpolation technique. Again, these parameters can be packaged and presented to the user for selection as a package.

### 1.2 Controlling Virtual Camera Behavior

Navigation through a virtual environment is driven by three aspects: purpose, personality and place. In regard to the first aspect, it is the purpose behind the navigation that dictates the way the user moves through the environment. For example, if the user is in a hurry, he or she wants to move fast and does not have time to look at everything in the virtual environment. If the user is a tourist with leisure time, he or she will want to explore and look around the virtual environment more completely. As is evident from these examples, the purpose aspect controls the navigation at the path definition level. This aspect has been covered in the previous path generation description.

Personality and place are also reflected in the generation of the path as described previously. However, these two aspects can be further incorporated into the personalized navigation technique embodiments described herein through controlling the behavior of the virtual camera as it reveals the scene to a user. Virtual camera control involves setting the camera parameters or properties as it moves along the path established through the virtual environment. Some of these parameters or properties include, but are not limited to, camera position, orientation (e.g., pointing angle or direction), focus, zoom, velocity along a path, pause times along a path, steady movement, jittery movement, and so on. In addition, cinematographic effects like Hitchcock zoom, or Ken burn effect can also be employed. Others variations can involve the kind of interpolation applied between keyframes, for example linear, parabolic, polynomial, spiral (e.g., key frames treated as points on a spiral) interpolation can be used. Still further, while the path established for the navigation will include velocity specification, the interpolation speed can be increased or decreased, thereby creating an accelerated or decelerated navigational experience.

As can be seen from the above listing there are many camera parameters that can be varied. Setting these parameters to various values can result in interesting camera motion styles. A subset of these styles of camera motion can be brought together to create a personalized navigating experience. To this end, these elementary behaviors or styles are grouped together to compose a personality aspect of the navigation experience. For example, elementary styles of camera behavior can grouped to alter or create small variations in the position of the camera resulting in hopping and skipping effect where the virtual camera exhibits up-down and left-right oscillations in time along the path (i.e., a combination of vertical camera oscillations and horizontal camera oscillations). Another example of grouping elemental camera behaviors involves changing the viewing angles after displacing the camera trajectory. In this way, a child's view can be generated by displacing the camera downwards and creating upward camera angles (i.e., a bottom-up view angle), or a bird's eye view can be generated by elevating the virtual camera and employing downward camera angles (i.e., a top-down view angle). Still further, significant variations in personality can also be modeled by combining elemental camera behaviors such as stop and focus at strategically chosen locations along the path, and varying the length of the pause at the chosen location. For example, the virtual camera can be pre-programmed to pause and zoom-in on a part of the virtual environment that depicts animals for a navigation scheme that would be interesting to children.

It is noted, however, that the place associated with a virtual environment is also considered when grouping elementary styles of camera behavior to create a personality. For example, one would explore an outdoor space in a different way than they would explore a museum. A bird's eye view would be appropriate for an outdoor space, but perhaps not desirable for an indoor site such as a museum.

Thus, to create a personalized experience for various environments through virtual camera control, information about the personality traits and preferences of the user, as well as the nature of virtual environment being navigated (e.g., outdoor/indoor, corridor/open hall, aerial view/walkthrough view, and so on), are input by the user. In one embodiment, elemental camera behaviors are pre-combined into groups believed to reflect the navigation experience a user, having a particular type of personality and visiting a particular type of place, would enjoy. The information entered by the user is then matched to one of these groups, and the elemental camera behaviors associated therewith are implemented during the navigation experience. It is noted that each group can also be given a label that is descriptive of the personality and place reflected by the group. A description of the navigation experience can also be created for each group. In this latter case, the information provided by the user can be in the form of the user selecting one of the groups using its label and associated description.

Further, in one implementation of the foregoing embodiment, not all the camera behaviors believed to reflect a particular personality and place are pre-defined in the groups. Rather, some (or in an extreme case—all) of the camera behavior attributes are left open so that they can be selected by the user. For example, the user could be allowed to select the amount of time the navigation pauses near points of interest, the preferred angle of viewing the scene, the preferred zoom/maximum closeness to points of interest, and so on. Thus, the user would be provided with the opportunity to select from not only one of the aforementioned groups, but also customize the navigation experience by selecting the open camera behavior attributes. In one implementation, the user would select from a list of available groups and its open attributes. The foregoing approach in which the user is allowed to personalize the navigation experience is not only advantageous as it allows the user to tailor the experience to his or her personality, but also allows the user to select a different group and attributes for viewing the environment on subsequent visits. This would give the user an incentive to revisit the virtual environment and view it from a different perspective.

In view of the foregoing, in one implementation the user navigation preferences are established as outlined in FIG. 9. First, elementary camera behaviors are grouped together that when employed during the navigation of the 3D environment reflect personal interests of a user and which are suited for the type of environment being navigated (900). Information about the personality traits and navigational preferences of the user, as well as the nature of virtual environment being navigated, is then input (902). The inputted information is matched to one of the groupings of elementary camera behaviors (904), and the matched grouping is designated as the user navigation preferences (906).

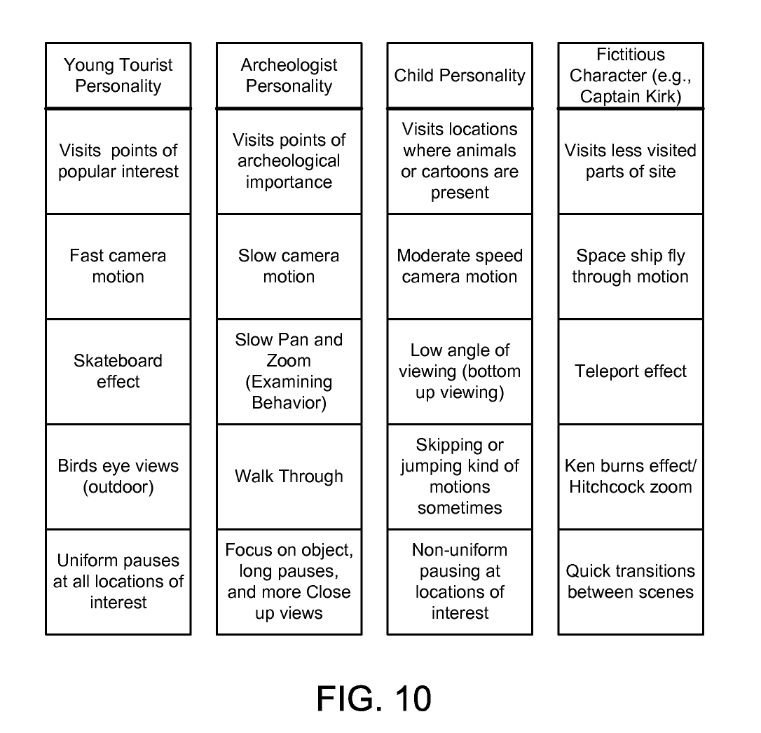

Some example camera behaviors groups are presented in FIG. 10. More particularly, tables of elemental camera behaviors that are grouped to reflect a particular personality type and sometimes a type of place are shown and labeled accordingly.

It is also noted that while controlling the camera behavior in the foregoing manner is described in conjunction with moving through the virtual environment along the path established in accordance with the personalized navigation technique embodiments described herein, this need not be the case. Rather the camera control aspects of the personalized navigation technique embodiments described herein can be implemented using a path generated in any manner.

### 2.0 The Computing Environment

A brief, general description of a suitable computing environment in which portions of the personalized navigation technique embodiments described herein may be implemented will now be described. The technique embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 11 illustrates an example of a suitable computing system environment. The computing system environment is only one example of a suitable computing environment and is not intended to suggest any limitation as to the scope of use or functionality of personalized navigation technique embodiments described herein. Neither should the computing environment be interpreted as having any dependency or requirement relating to any one or combination of components illustrated in the exemplary operating environment. With reference to FIG. 11, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 11 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 11 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well known in the art and need not be discussed at length here.

The personalized navigation technique embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

### 3.0 Other Embodiments

In the foregoing description of embodiments for personalized navigation through a virtual 3D environment, is is presumed that the user follows the established path at some computed velocity. However, in an alternate embodiment, once the nodes of the path (refined or otherwise) which correspond to the landmark regions are established, it is not necessary that the user follow a path through the virtual environment between the nodes. Rather, a teleportation experience can be implemented where the user instantaneously jumps from one node to another. It is noted that depending on the user's preferences not all the node need to be visited.

It is further noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for providing personalized navigation through a virtual three-dimensional (3D) environment, comprising:
using a computer to perform the following process actions:
inputting a representation of the virtual 3D environment;
inputting user specified navigation preferences; and
establishing a path through the virtual 3D environment which is customized using the user specified navigation preferences.

2. The process of claim 1, wherein the representation of the virtual 3D environment is in the form of a photosynth comprising images of the environment, feature point cloud data and keyframe point data, wherein the feature point cloud data comprises a set of 3D matching points identified among the images making up the photosynth, and wherein the keyframe point data represents locations where a camera was situated when capturing a photosynth image.

3. The process of claim 2, wherein the process action of establishing a path through the virtual 3D environment, comprises the actions of:
defining a region in the virtual environment where the path will be laid out;
building a region of interest grid from the defined region; and
generating a course road-map path in the form of a graph through the virtual 3D environment based on the region of interest grid.

4. The process of claim 3, wherein the process action of defining a region in the virtual environment where the path will be laid out, comprises the actions of:
projecting the feature point cloud onto a two-dimensional (2D) X-Y plane;
overlaying the projected feature point cloud with an axis-parallel rectangular grid that extends along each of its X and Y grid axes so as to cover a maximum range of the feature point cloud points;
counting the number of feature point cloud points lying in each cell of grid; and
for each cell of the grid,
determining if the number of feature point cloud points therein is below a prescribed minimum point count threshold, and
whenever it is determined that the number of feature point cloud points in a grid cell is below the prescribed minimum point count threshold, designating the grid cell as an empty grid cell and discarding the feature point cloud points therein.

5. The process of claim 4, wherein the grid has rectangular shaped grid cells and the minimum point count threshold is set to 100*(width/wn)*(height/hn), wherein width and height are the width and height of the grid, and wn=number of grid cells along the width, and hn=number of grid cells along the height.

6. The process of claim 4, wherein the process action of building a region of interest grid from the defined region, comprises the actions of:
establishing a rectangular bounding box on the plane which aligns with the grid, and encompasses all the grid cells which are contiguous with each other and still having feature point cloud points therein;
projecting the keyframe points onto the plane; and
designating the portion of the grid inside the bounding box as a region of interest grid.

7. The process of claim 6, wherein the process action of generating a course road-map path in the form of a graph through the virtual 3D environment based on the region of interest grid, comprises the actions of:
clustering the keyframe points resident inside the region of interest grid into landmark regions;
for each landmark region,
computing a mean location of the region, and
designating the keyframe point location closest to the mean location as a node of a road-map graph;
connect the nearest neighboring nodes of the road-map graph with edges; and
designating the path formed by the road-map graph nodes and edges as the course road-map path through the virtual 3D environment.

8. The process of claim 7, wherein the process action of clustering the keyframe points resident inside the region of interest grid into landmark regions, comprises an action of clustering the keyframe points using an agglomerative hierarchical clustering technique based on the mean Euclidean distance between landmark locations and a prescribed distance threshold as metrics to achieve the clustering.

9. The process of claim 4, wherein the process action of projecting the feature point cloud onto a two-dimensional (2D) X-Y plane, comprises an action of projecting the feature point cloud onto a plane that transects the 3D virtual environment as represented by the feature point cloud of the photosynth such that it is substantially parallel with a prescribed ground level of the environment and at a height above the ground level approximately corresponding to an adult's eye-level.

10. The process of claim 3, wherein the process action of establishing a path through the virtual 3D environment, further comprises the actions of:
constructing a region of interest graph; and
refining the course road-map path through the virtual 3D environment in a first refinement stage using the region of interest graph to produce a first refined path which comprises a sequence of nodes and which exhibits a resolution consistent with the region of interest grid.

11. The process of claim 10, wherein the process action of constructing the region of interest graph, comprises the actions of:
establishing a node of the region of interest graph at a corner of each grid cell of the region of interest grid, wherein the same grid cell corner is employed for each node established;
establishing edges between each node and its neighboring nodes, wherein only nodes corresponding to cells adjacent to that associated with a given node are deemed to be neighbors to that node; and
assigning a weight to each edge, wherein the edge weight is computed based on a prescribed set of parameters comprising the number of feature point cloud points and keyframe points in the cell associated with the node where the edge originates, the Euclidean edge length, and the number of feature point cloud points and keyframes in the cell associated with the node where the edge terminates.

12. The process of claim 11, wherein the process action of refining the course road-map path through the virtual 3D environment in the first refinement stage, comprises the actions of:
projecting the course road-map path graph onto the region of interest grid;
establishing a primary node location of a first refined path at a corner of each grid cell of the region of interest grid containing a node of the road-map path graph, wherein the same grid cell corner is employed for each primary node established;
employing an A-star technique to trace the first refined path along either a grid cell line of a grid cell of the region of interest grid or diagonally across a grid cell of the region of interest grid, between each successive primary node location, based on the edge weights computed for the edges in the region of interest graph which correspond to the grid cell lines of the region of interest grid; and
designating each grid cell corner along the first refined path as a node of the first refined path.

13. The process of claim 10, wherein the process action of establishing a path through the virtual 3D environment, further comprises the actions of:
constructing a static force grid; and
refining the first refined path through the virtual 3D environment to give the user a more realistic navigation experience in a second refinement stage to produce a final refined path using the static force grid.

14. The process of claim 13, wherein the process action of constructing a static force grid, comprises the actions of:
for each cell of the region of interest grid,
assigning a charge value to each keyframe and feature point cloud point in the cell, wherein each keyframe is assigned a prescribed attracting charge and each feature point cloud point is assigned a prescribed repulsing charge, and
computing a combined charge at an averaged charge location of the cell, wherein the averaged charge location is computed as the mean location of all the keyframe and feature point cloud points within the cell and the combined charge assigned to the mean location is computed as the sum of the charges assigned to each keyframe and feature point cloud point within the cell weighted by the distance of the point from the averaged charge location of the cell.

15. The process of claim 14, wherein the process action of refining the first refined path through the virtual 3D environment in the second refinement stage, comprises the actions of:
for each segment of the first refined path traversing a grid cell between nodes,
designating the point where the path enters the cell as the source location and the point where the path leaves the cell as the destination location;
assigning the destination location an attractive force;
identifying a set of neighboring grid cells depending on whether the path segment under consideration is horizontal or vertical or diagonal;
identifying the combined charge emanating from the averaged charge location of each cell of the static force grid that corresponds to one of the identified neighboring grid cells;
using a potential field-driven interpolation technique to establish a revised route for the path segment under consideration to take through the grid cell under consideration and a velocity associated with path through the cell, based on the identified combined charges associated with the neighboring cells and the attractive force assigned to the destination location of the grid cell under consideration.

16. The process of claim 15, wherein the process action of identifying the set of neighboring grid cells depending on whether the path segment under consideration is horizontal or vertical or diagonal, comprises the actions of:
identifying the grid cells immediately above and below the grid cell under consideration as the set of neighboring grid cells, whenever the path segment under consideration is horizontal along an edge of the grid cell;
identifying the grid cells immediately before and after the grid cell under consideration as the set of neighboring grid cells, whenever the path segment under consideration is vertical along an edge of the grid cell; and
identifying the grid cells immediately above, below, before and after the grid cell under consideration as the set of neighboring grid cells, whenever the path segment under consideration is diagonal through the grid cell.

17. A computer-implemented process for providing personalized navigation through a virtual three-dimensional (3D) environment, comprising:
using a computer to perform the following process actions:
inputting a representation of the virtual 3D environment;
establishing user navigation preferences; and
controlling the behavior of a virtual camera based on the user navigation preferences as the virtual camera reveals the virtual 3D environment to the user as the user traverses a pre-established a path through the virtual 3D environment.

18. The process of claim 17, wherein the process action of controlling the behavior of a virtual camera based on the user specified navigation preferences, comprises an action of controlling virtual camera motion and camera-based cinematographic effects to reflect personal interests established by the user specified navigation preferences.

19. The process of claim 17, wherein the process action of establishing user navigation preferences, comprises the actions of:
grouping together elementary camera behaviors that when employed during the navigation of the 3D environment reflect personal interests of a user and which are suited for the type of environment being navigated;
inputting information about the personality traits and navigational preferences of the user, as well as the nature of virtual environment being navigated;
matching the inputted information to one of the groupings of elementary camera behaviors; and
designating the grouping of elemental camera behaviors matched to the inputted information as the user navigation preferences.

20. A computer-implemented process for providing personalized navigation through a virtual three-dimensional (3D) environment, comprising:
using a computer to perform the following process actions:
inputting a representation of the virtual 3D environment;
inputting user specified navigation preferences; and
establishing a path through the virtual 3D environment which is customized using the user specified navigation preferences; and
controlling the behavior of a virtual camera based on the user specified navigation preferences, wherein the virtual camera reveals the virtual 3D environment to the user as the user traverses said path.
